(19) United States
(12) Patent Application Publication
(10) Pub. No.: US 2018/0123800 A1
(43) Pub. Date: May 3, 2018

(54) METHOD AND APPARATUS FOR DE-DUPLICATING ENCRYPTED FILE THROUGH VERIFICATION OF FILE POSSESSION, AND METHOD AND APPARATUS FOR STORING ENCRYPTED FILE

(71) Applicant: ELECTRONICS AND TELECOMMUNICATIONS RESEARCH INSTITUTE, Daejeon (KR)

(72) Inventors: Keonwoo KIM, Daejeon (KR); Taek-Young YOUN, Daejeon (KR); Ku Young CHANG, Daejeon (KR); Nam-Su JHO, Daejeon (KR)

(21) Appl. No.: 15/586,180

(22) Filed: May 3, 2017

(30) Foreign Application Priority Data
Oct. 31, 2016 (KR) 10-2016-0143636

(51) Int. Cl. H04L 9/32; G06F 21/60; H04L 9/08

(52) U.S. Cl. CPC H04L 9/3236; G06F 21/602; G06F 17/30156; H04L 9/0861; H04L 9/0822

(57) ABSTRACT

A method for storing an encrypted file by a server is provided. The server receives a first encrypted file identifier from a client. The server generates a random number and transmits the random number to the client, when the first encrypted file identifier is present in a first database. The server generates a first verification value using the random number. In addition, the server confirms whether or not the client possesses a first encrypted file corresponding to the first encrypted file identifier among encrypted files stored in a second database by comparing the first verification value and a second verification value based on the random number with each other, when receiving the second verification value from the client.

### CROSS-REFERENCE TO RELATED APPLICATION

This application claims priority to and the benefit of Korean Patent Application No. 10-2016-0143636 filed in the Korean Intellectual Property Office on Oct. 31, 2016, the entire contents of which are incorporated herein by reference.

### BACKGROUND OF THE INVENTION

### (a) Field of the Invention

The present invention relates to a method and an apparatus for de-duplicating an encrypted file. The present invention also relates to a method and an apparatus for storing an encrypted file.

### (b) Description of the Related Art

In a technical field of de-duplicating an encrypted file, technology of hashing plane text files to generate encryption keys, generating encrypted files using the generated encryption keys and the plane text files, and hashing the encryption keys or the encrypted files to generate encrypted file identifiers has been already known.

In an existing method for de-duplicating an encrypted file, it is confirmed whether or not the same encrypted file is present using the encrypted file identifier, only related metadata are transmitted when the same encrypted file is present, and the encrypted file is uploaded when the same encrypted file is not present.

However, according to such a method, when a user informs another user of the encrypted file identifier, another user may obtain authority to download the encrypted file only using the encrypted file identifier although he/she does not possess an actual file.

In addition, since integrity of an uploaded file is not verified in such a method, such a method is vulnerable to a duplicated impersonation attack by a malicious attack.

Further, such a method includes only file encryption/decryption methods for de-duplicating the encrypted file and a method for generating the encrypted file identifier, and does not include detailed operations performed by a client and a server in order to de-duplicate the encrypted file.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for preventing a user (or a client) that does not possess an actual file from downloading a file through a de-duplicating process using an encrypted file identifier.

Further, the present invention has been made in an effort to provide a method and an apparatus for de-duplicating an encrypted file having advantages of being safe against a duplicated impersonation attack.

An exemplary embodiment of the present invention provides a method for storing an encrypted file by a server. The method for storing an encrypted file by a server includes: receiving a first encrypted file identifier from a client; generating a random number and transmitting the random number to the client, when the first encrypted file identifier is present in a first database; generating a first verification value using the random number; and confirming whether or not the client possesses a first encrypted file corresponding to the first encrypted file identifier among encrypted files stored in a second database by comparing the first verification value and a second verification value based on the random number with each other, when receiving the second verification value from the client.

The generating of the first verification value may include hashing the first encrypted file and the random number to calculate the first verification value.

The second verification value may be calculated by the client by hashing a second encrypted file possessed by the client and the random number.

The confirming may include requesting the client to transmit only a first file encryption key for the first encrypted file, of the first encrypted file and the first file encryption key and receiving the first file encryption key, when the first verification value and the second verification value coincide with each other.

The first file encryption key may be a file encryption key encrypted through a private secret key uniquely allocated to the client.

The first database may store the first encrypted file identifier and a first client identifier list associated with the first encrypted file identifier.

The confirming may include adding a first client identifier of the client to the first client identifier list when the first verification value and the second verification value coincide with each other.

The confirming may further include storing a first client identifier of the client, the first encrypted file identifier, and the first file encryption key in a third database.

The confirming may include deciding that the client does not possess the first encrypted file and informing the client of fail, when the first verification value and the second verification value are different from each other.

A second file encryption key may be generated by hashing for a first plane text file.

The first encrypted file identifier may be generated by hashing for the second file encryption key.

The first encrypted file may be generated by applying encryption based on the second file encryption key to the first plane text file.

The first file encryption key may be generated by applying encryption based on the private secret key to the second file encryption key.

The method for storing an encrypted file by a server may further include: requesting the client to transmit a second encrypted file possessed by the client and a first file encryption key for the second encrypted file and receiving the second encrypted file and the first file encryption key, when the first encrypted file identifier is not present in the first database.

The receiving of the second encrypted file and the first file encryption key may include: storing the first encrypted file identifier and a first client identifier of the client in the first database; storing the first encrypted file identifier and the second encrypted file in the second database; and storing the first client identifier, the first encrypted file identifier, and the first file encryption key in a third database.

The first database and the second database may be physically separated from each other.

Another exemplary embodiment of the present invention provides a method for storing an encrypted file in a server by a client. The method for storing an encrypted file in a server by a client includes: transmitting a first client identifier of the client and a first encrypted file identifier for a first encrypted file to the server; receiving a random number from the server when the first encrypted file identifier is present in the server; hashing the random number and the first encrypted file to generate a first verification value; and transmitting the first verification value to the server.

The method for storing an encrypted file in a server by a client may further include: before the transmitting of the first client identifier and the first encrypted file identifier, encrypting a first file encryption key for the first encrypted file using a private secret key allocated to the client to generate a second file encryption key; and transmitting only the second file encryption key of the first encrypted file and the second file encryption key to the server, when the first verification value and a second verification value generated by the server coincide with each other.

The method for storing an encrypted file in a server by a client may further include: before the transmitting of the first client identifier and the first encrypted file identifier, encrypting a first file encryption key for the first encrypted file using a private secret key allocated to the client to generate a second file encryption key; and receiving a fail message from the server, when the first verification value and a second verification value generated by the server are different from each other.

The method for storing an encrypted file in a server by a client may further include: before the transmitting of the first client identifier and the first encrypted file identifier, encrypting a first file encryption key for the first encrypted file using a private secret key allocated to the client to generate a second file encryption key; and transmitting the first encrypted file and the second file encryption key to the server, when the first encrypted file identifier is not present in the server.

The method for storing an encrypted file in a server by a client may further include: hashing a first plane text file to generate a first file encryption key; hashing the first file encryption key to generate the first encrypted file identifier; encrypting the first plane text file using the first file encryption key to generate the first encrypted file; and encrypting the first file encryption key using a private secret key allocated to the client to generate a second file encryption key.

Yet another exemplary embodiment of the present invention provides a server. The server includes a first database; and a processor searching a first encrypted file identifier in the first database when the first encrypted file identifier is received from a client.

The processor may transmit a random number to the client and hash a first encrypted file corresponding to the first encrypted file identifier among encrypted files stored in a second database and the random number to generate a first verification value, when the first encrypted file identifier is searched.

The processor may compare the first verification value and a second verification value based on the random number with each other to confirm whether or not the client possesses the first encrypted file, when the second verification value is received from the client.

The processor may request the client to transmit only a first file encryption key for the first encrypted file, of the first encrypted file and the first file encryption key and receive the first file encryption key, when the first verification value and the second verification value coincide with each other.

The processor may add a first client identifier of the client to a first client identifier list corresponding to the first encrypted file identifier among client identifier lists stored in the first database, when the first verification value and the second verification value coincide with each other.

The processor may store a first client identifier of the client, the first encrypted file identifier, and the first file encryption key in a third database.

The processor may decide that the client does not possess the first encrypted file and inform the client of fail, when the first verification value and the second verification value are different from each other.

### BRIEF DESCRIPTION OF THE DRAWINGS

FIG. 1 is a view showing a method for de-duplicating an encrypted file that a client intends to upload by the client and a server in the case in which the encrypted file is already present in the server, according to an exemplary embodiment of the present invention.

FIG. 2 is a view showing a structure of a server database in which an encrypted file and metadata related to the encrypted file are stored, according to an exemplary embodiment of the present invention.

FIG. 3 is a view showing a method for uploading an encrypted file that a client intends to upload by the client in the case in which the encrypted file is not present in the server, according to an exemplary embodiment of the present invention.

FIG. 4 is a flowchart showing a process of de-duplicating an encrypted file by a client according to an exemplary embodiment of the present invention.

FIG. 5 is a flowchart showing a process of de-duplicating an encrypted file by a server according to an exemplary embodiment of the present invention.

FIG. 6 is a view showing a computer apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the present specification, an overlapped description for the same components will be omitted.

Further, in the present specification, it is to be understood that when one component is referred to as being ‘connected to’ another component, it may be connected directly to another component or be connected to another component with the other component interposed therebetween. On the other hand, it is to be understood that when one component is referred to as being ‘directly connected to’ another component, it may be connected to another component without the other component interposed therebetween.

In addition, terms used in the present specification are used only in order to describe specific exemplary embodiments rather than limiting the present invention.

Further, in the present specification, singular forms are intended to include plural forms unless the context clearly indicates otherwise.

Further, in the present specification, it will be understood that the terms ‘include’ or ‘have’, specify the presence of features, numerals, steps, operations, components, parts, or combinations thereof mentioned in the present specification, or a combination thereof, but do not preclude the presence or addition of one or more other features, numerals, steps, operations, components, parts, or combinations thereof.

Further, in the present specification, a term ‘and/or’ includes a combination of a plurality of stated items or any one of the plurality of stated items. In the present specification, ‘A or B’ may include ‘A’, ‘B’, or ‘both of A and B’.

Hereinafter, a method for de-duplicating an encrypted file by a client and a server (hereinafter, referred to as a method for de-duplicating an encrypted file) and operations for the method will be described. In addition, hereinafter, a method for storing an encrypted file transmitted from a client to a server depending on whether or not the encrypted file is duplicated and metadata related to the encrypted file in a database (DB) of the server will be described.

In the present specification, a client means a computer apparatus (or a terminal) of a user that intends to store (or upload) a file in a cloud service, a data storage server, or the like. In detail, the client means a computer apparatus (or a terminal) of a user using a server in order to store an encrypted file.

In the present specification, the server may be a cloud storage server, a data storage server, and the like. In detail, the server may have a database for storing the encrypted file and the metadata related to the encrypted file.

The server may decide whether or not the client possesses an actual file through comparison of a verification value, and de-duplicate the encrypted file on the basis of a result of the decision. In detail, the client and the server may use an encrypted file identifier in order to confirm whether or not the encrypted file is duplicated. In addition, the client and the server may calculate verification values, respectively. In addition, the server may compare the calculated verification values with each other to confirm whether or not the client possesses the same encrypted file.

Therefore, the client does not transmit all the encrypted files to the server, but may transmit (upload) only encrypted files that are not duplicated to the server.

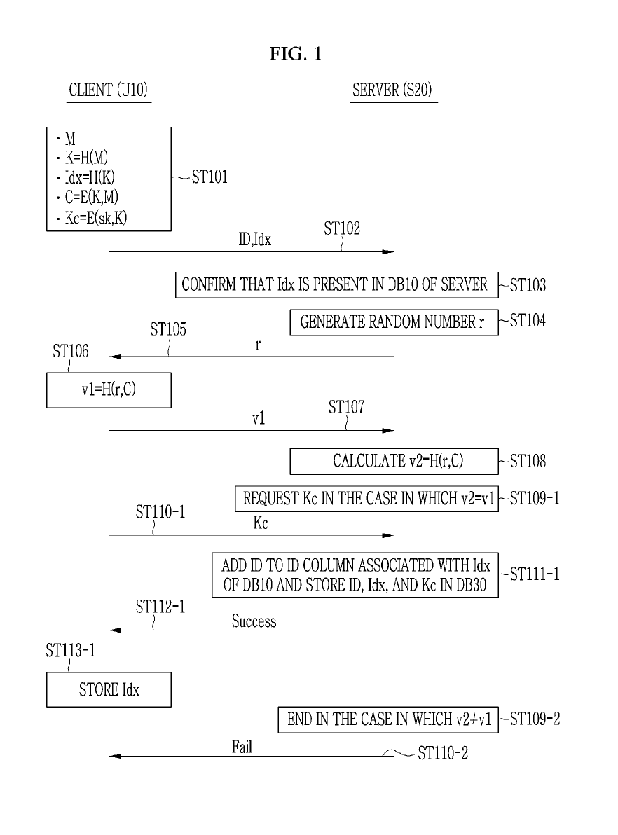

FIG. 1 is a view showing a method for de-duplicating an encrypted file that a client intends to upload by the client and a server in the case in which the encrypted file is already present in the server, according to an exemplary embodiment of the present invention.

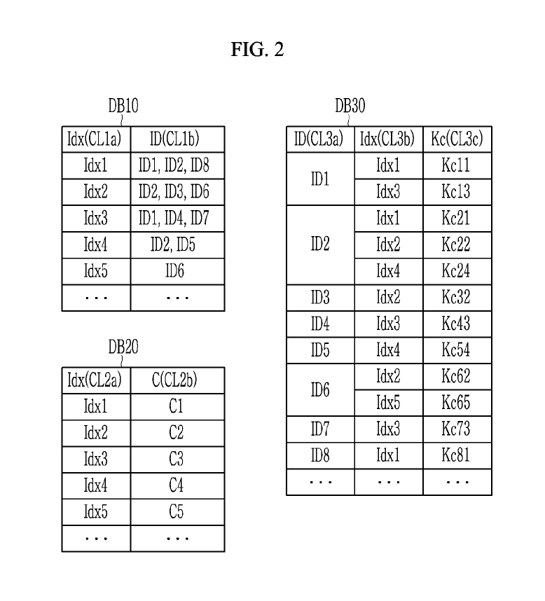

In addition, FIG. 2 is a view showing a structure of a server database in which an encrypted file and metadata related to the encrypted file are stored, according to an exemplary embodiment of the present invention. In detail, a database DB10 of a server S20 includes an Idx column CL1a storing encrypted file identifiers (for example, Idx1, Idx2, . . . ) and an ID column CL1b storing client identifiers (for example ID1, ID2, . . . ). A database DB20 of the server 20 includes an Idx column CL2a storing encrypted file identifiers (for example, Idx1, Idx2, . . . ) and a C column CL2b storing encrypted files (for example C1, C2, . . . ). A database DB30 of the server S20 includes an ID column CL3a storing client identifiers (for example, ID1, ID2, . . . ), an Idx column CL3b storing encrypted file identifiers (for example, Idx1, Idx2, . . . ), and a Kc column CL3c storing encrypted file encryption keys (for example, Kc11, kc21, . . . ).

A detailed process will be described below.

A client U10 hashes (for example, H(M)) a plane text file M to generate a file encryption key K (ST101). Here, H() means a hash function. In addition, the client U10 hashes (for example, H(K)) the file encryption key K to generate an encrypted file identifier Idx for identifying an encrypted file C (ST101).

The client U10 encrypts (for example, E(K, M)) the plane text file M using the file encryption key K in order to generate the encrypted file C (ST101). Here, E() means an encryption function.

The client U10 encrypts (for example, E(sk, K)) the file encryption key K using a private secret key sk of the client U10 in order to generate an encrypted file encryption key Kc (ST101). Here, the private secret key sk is a private secret key secretly possessed by each client U10. That is, the private secret key sk is a private secret key uniquely allocated to each client U10. As a result, different clients U10 may possess different private secret keys sk.

In detail, ST101 may be represented by the following Equation.

M, K=H(M), Idx=H(K), C=E(K,M), Kc=E(sk,K)

The client U10 transmits his/her unique client identifier ID and an encrypted file identifier Idx to the server S20 (ST102) in order to confirm whether or not the encrypted file C that he/she intends to upload is already stored in the server S20.

The server S20 confirms whether or not the same encrypted file identifier as the encrypted file identifier Idx received from the client U10 is present in the database DB10 (ST103). That is, the server S20 searches the received encrypted file identifier Idx in the database DB10.

When the same encrypted file identifier Idx is present in the database DB10, the server S20 generates a random number r (ST104).

The server S20 transmits the random number r to the client U10 (ST105).

In the case in which the client U10 receives the random number r, the client U10 hashes (for example, H(r,C)) the random number r and the encrypted file C possessed by the client U10 to generate a first verification value v1 (ST106). In detail, ST106 may be represented by the following Equation.

v1=H(r,C)

The client U10 transmits the first verification value v1 to the server S20 (ST107).

In the case in which the server S20 receives the first verification value v1, the server S20 searches the encrypted file C associated with the encrypted file identifier Idx received in ST102 in the database DB20 (ST108). In addition, the server S20 hashes (for example, H(r,C)) the searched encrypted file C and the random number generated in ST104 together to generate a second verification value v2 (ST108). In detail, ST108 may be represented by the following Equation.

v2=H(r,C)

Meanwhile, the server S20 may also perform ST108 before it receives the first verification value v1.

A process after ST108 may be divided into ST109-1 to ST113-1 and ST109-2 and ST110-2 depending on whether or not the first verification value v1 and the second verification value v2 are the same as each other.

The server S20 verifies whether or not the first verification value v1 and the second verification value v2 are the same as each other (ST109-1). When the first verification value v1 and the second verification value v2 are the same as each other, the server S20 requests the client U10 to transmit the encrypted file encryption key Kc (ST109-1). When plane text files M possessed by a plurality of clients U10 are the same as one another, the same file encryption key K and encrypted file C are generated in each of the plurality of clients U10. However, since different clients U10 possess different private secret keys sk, even though the file encryption keys K are the same as one another, the respective clients U10 have different encrypted file encryption keys Kc.

The client U10 transmits the encrypted file encryption key Kc to the server S20 (ST110-1).

The server S20 adds the client identifier ID of the client U10 to the ID column CL1b of the database DB10 using the encrypted file identifier Idx (ST111-1). For example, when the client identifier ID received in ST102 is ID2 and the encrypted file identifier Idx received in ST102 is Idx2, the server S20 may add the client identifier ID2 to a field associated with the encrypted file identifier Idx2 among fields of the ID column CL1b. In this case, other client identifiers (for example, ID3, ID6, and the like) may be already present in the field associated with the encrypted file identifier Idx2, and the client identifier ID2 is added to such as client identifier list. That is, the client identifier ID2 is added to a client identifier list corresponding to the encrypted file identifier Idx2 among client identifier lists stored in the database DB10.

In addition, the server S20 stores the client identifier (for example, ID2), the encrypted file identifier (for example, Idx2), and the encrypted file encryption key (for example, Kc22) received in ST110-1 in the database DB30 (ST111-1). Meanwhile, since the encrypted file C that the client U10 intends to upload is already stored in the database DB20, it is not newly stored in the database DB20.

The server S20 informs the client U10 of success of the de-duplication (ST112-1).

In addition, the client U10 stores the encrypted file identifier Idx corresponding to the encrypted file C (ST113-1) in order to download the encrypted file C from the server S20 later.

Meanwhile, in the case in which the first verification value v1 and the second verification value v2 are different from each other, the server S20 decides that the client U10 does not possess the corresponding encrypted file C (ST109-2).

In this case, the server S20 informs the client U10 of fail of the de-duplication (ST110-2). For example, the client U10 may receive a de-duplication fail message from the server S20.

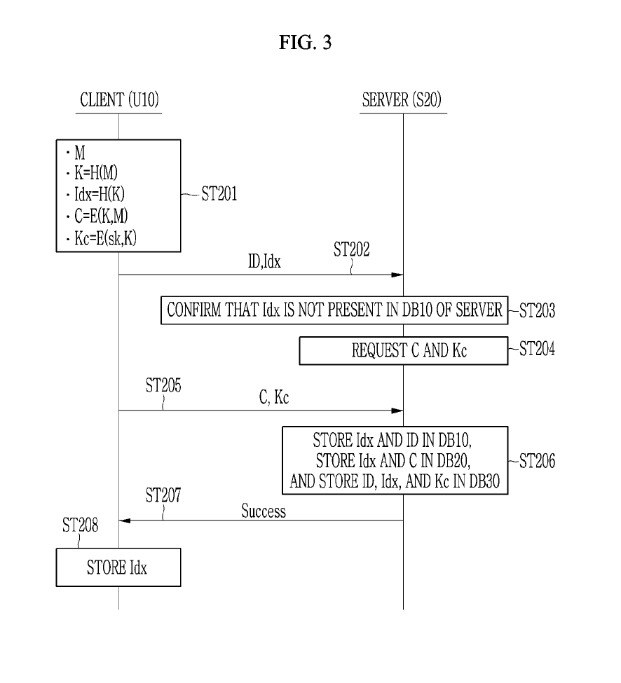

FIG. 3 is a view showing a method for uploading an encrypted file that a client intends to upload by the client in the case in which the encrypted file is not present in the server, according to an exemplary embodiment of the present invention.

ST201 shown in FIG. 3 is the same as ST101 shown in FIG. 1.

ST202 shown in FIG. 3 is the same as ST102 shown in FIG. 1.

The server S20 confirms that the same encrypted file identifier as the encrypted file identifier Idx received from the client U10 is not present in the database DB10 (ST203).

When the same encrypted file identifier Idx is not present, the server S20 requests the client U10 to transmit the encrypted file C and the encrypted file encryption key Kc (ST204).

The client U10 transmits the encrypted file C and the encrypted file encryption key Kc for the encrypted file to the server S20 (ST205).

The server S20 stores the encrypted file identifier Idx received in ST202 in the Idx column CL1a of the database DB10, and stores the client identifier ID received in ST202 in the ID column CL1b of the database DB10 (ST206).

In addition, the server S20 stores the encrypted file identifier Idx received in ST202 and the encrypted file C received in ST205 in the database DB20 (ST206).

In addition, the server S20 stores the client identifier ID and the encrypted file identifier Idx received in ST202 and the encrypted file encryption key Kc received in ST205 in the database DB30 (ST206).

The server S20 informs the client U10 of success of the upload (ST207).

The client U10 stores the encrypted file identifier Idx corresponding to the encrypted file C (ST208) in order to download the encrypted file C from the server S20 later.

Meanwhile, structures of the databases DB10, DB20, and DB30 described above are as follows.

The databases DB10, DB20, and DB30 possessed by the server S20 are divided into the database DB20 for storing the encrypted file C and the databases DB10 and DB30 for storing metadata (for example, Idx, ID, or Kc) related to the encrypted file C. The databases DB10, DB20, and DB30 may be physically implemented in one database server or a plurality of database servers. For example, the database DB20 and the databases DB10 and DB30 may be physically separated from each other.

Here, the metadata may include the encrypted file identifier Idx, the client identifier ID, the encrypted file encryption key Kc, or the like.

The database DB10 stores the encrypted file identifier Idx and the client identifier ID. The database DB20 stores the encrypted file identifier Idx and the encrypted file C corresponding to the encrypted file identifier. In addition, the database DB30 stores the client identifier ID, the encrypted file identifier Idx, and the encrypted file encryption key Kc. That is, the database DB10 and the database DB30 are databases for storing the metadata, and the database DB20 is a database for storing the actual encrypted data C.

As shown in the database DB10 of FIG. 2, one encrypted file identifier Idx may be associated with one client identifier ID or a plurality of client identifiers IDs. As an example, when two clients (for example, U10-2 and U10-3) possess the same one encrypted file (for example, C2), both of the two clients (U10-2 and U10-3) possess the same encrypted file identifier (for example, Idx2) corresponding to the encrypted file C2. As a result, the encrypted file identifier Idx2 is stored in the Idx column CL1a of the database DB10, and client identifiers (for example, ID2 and ID3) of the clients U10-2 and U10-3 are stored in the ID column CL1b associated with the encrypted file identifier Idx2.

Here, in the case in which another client (for example, U10-6) intends to store his/her encrypted file (for example, C2) in the server S20, the encrypted file identifier Idx2 corresponding to the encrypted file C2 is already present in the database DB10, and thus, the client U10-6 does not need to upload the encrypted file C2 to the server S20. However, in order to enable the client U10-6 to download the encrypted file C2 later, the server S20 adds a client identifier (for example, ID6) of the client U10-6 to a field associated with the encrypted file identifier Idx2 among fields of the ID column CL1b. As a result, the client identifier ID6 is added to an existing client identifier list, such that the client identifiers ID2, ID3, and ID6 are stored in the field associated with the encrypted file identifier Idx2 among the fields of the ID column CL1b.

As another example, when three clients (for example, U10-1, U10-4, and U10-7) possess the same one encrypted file (for example, C3), all of the three clients (U10-1, U10-4, and U10-7) possess an encrypted file identifier (for example, Idx3) corresponding to the encrypted file C3. As a result, the encrypted file identifier Idx3 is stored in the Idx column CL1a of the database DB10, and client identifiers (for example, ID1, ID4, and ID7) of the clients (U10-1, U10-4, and U10-7) are stored in a field associated with the encrypted file identifier Idx3 among fields of the ID column CL1b.

As shown in the database DB20 of FIG. 2, necessarily one encrypted file C is stored with respect to one encrypted file identifier Idx. For example, in the case in which three clients (for example, U10-2, U10-3, and U10-6) possess the same one encrypted file (for example, C2) and an encrypted file identifier (for example, Idx2) corresponding to the encrypted file C2, the encrypted file identifier Idx2 is stored in the Idx column CL2a of the database DB20, and the encrypted file C2 is stored in the C column CL2b associated with the encrypted file identifier Idx2. As a result, the encrypted files C2 of each of the clients U10-2, U10-3, and U10-6 are not duplicatedly (for example, three encrypted files) stored in the database DB20, but only one encrypted file C2 is stored in the database DB20.

As shown in the database DB30 of FIG. 2, one or more encrypted file identifiers Idx and one or more encrypted file encryption keys Kc may be stored with respect to one client identifier ID. The reason is that even though encrypted files C of each client U10 are the same as one another, encrypted file encryption keys Kc of each client U10 are different from one another. That is, even though different clients U10 possess the same encrypted file identifier Idx, unique private secret keys sk of the clients U10 possessing the same encrypted file identifier Idx are different from one another, such that the encrypted file encryption keys Kc of each client U10 are different from one another. As a result, the database DB30 stores the encrypted file identifiers Idx possessed by each client U10 and the encrypted file encryption keys Kc corresponding to encrypted file identifiers Idx with respect to each client identifier ID.

As an example, assume that three clients (for example, U10-2, U10-3, and U10-6) possess the same one encrypted file (for example, C2) and an encrypted file identifier (for example, Idx2) corresponding to the encrypted file. Since the clients U10-2, U10-3, and U10-6 encrypt a file encryption key K using unique private secret keys (for example, sk2, sk3, and sk6), respectively, the file encryption keys (for example, Kc22, Kc32, and Kc62) encrypted by the respective clients U10-2, U10-3, and U10-6 are different from one another. As a result, ID2, Idx2, and Kc22 for a client identifier (for example, ID2) of the client U10-2 are stored in the database DB30, ID3, Idx2, and Kc32 fora client identifier (for example, ID3) of the client U10-3 are stored in the database DB30, and ID6, Idx2, and Kc62 for a client identifier (for example, ID6) of the client U10-6 are stored in the database DB30.

As another example, in the case in which two encrypted files Cl and C3 for a client identifier (for example, ID1) of a client (for example, U10-1) are stored in the database DB20, encrypted file encryption keys (for example, Kc11 and Kc13) of the encrypted files C1 and C3 are stored in the database DB30. That is, ID1, Idx2, and Kc11 and ID1, Idx3, and Kc13 for the client identifier ID1 are stored in the database DB30. Here, in the case in which an encrypted file C1 for a client identifier (for example, ID2) of a client (for example, U10-2) is stored in the database DB20, an encrypted file encryption key of the encrypted file C1 is different from the encrypted file encryption key Kc11 of the client identifier ID1 and is thus newly stored in the database DB30. That is, ID2, Idx1, and Kc21 for the client identifier ID2 are stored in the database DB30.

Efficiency of searching, storing, managing, and the like, of databases may be improved through the structures of the databases DB10, DB20, and DB30 shown in FIG. 2.

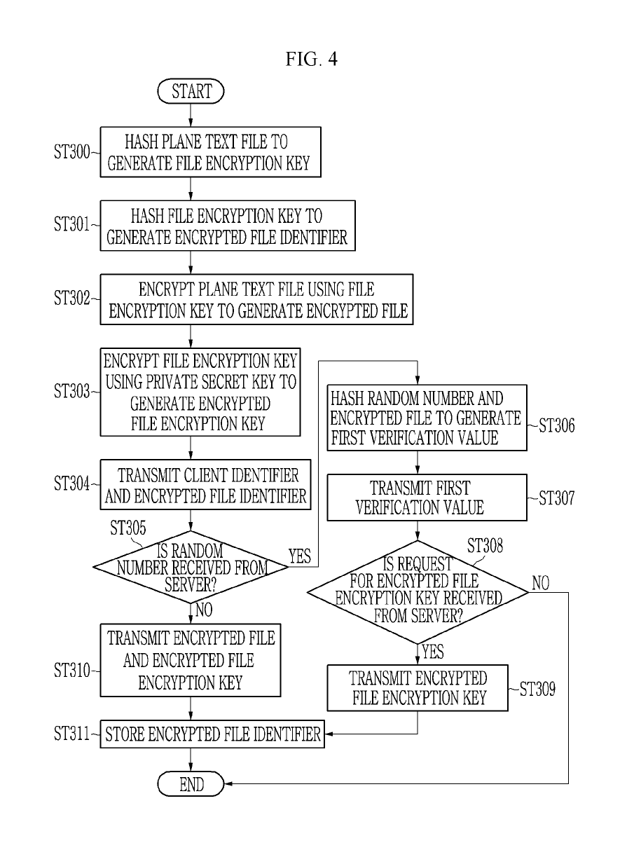

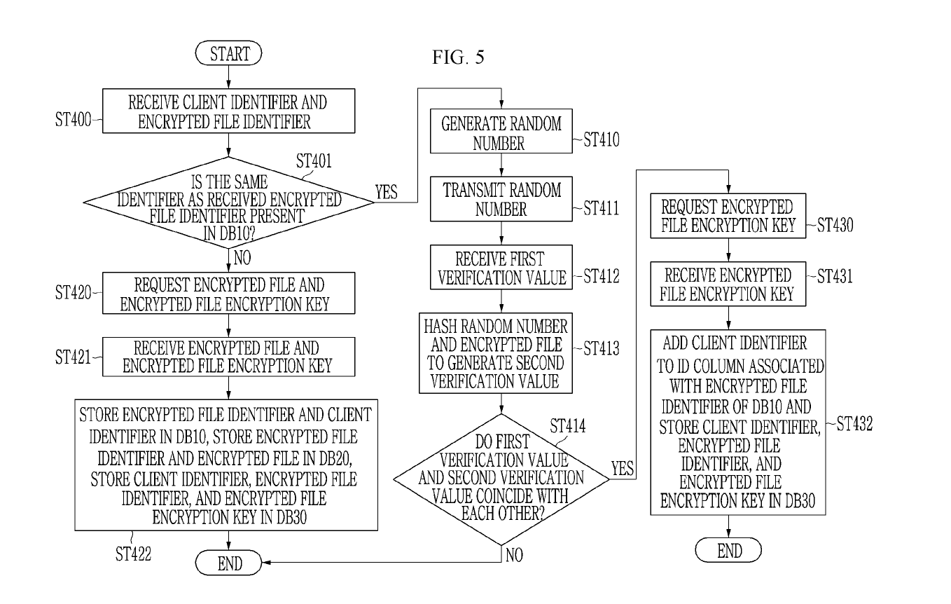

Operations performed by the client U10 among the operations of the method for de-duplicating an encrypted file described above will be described with reference to FIG. 4. That is, a method for storing the encrypted file C in the server S20 by the client U10 will be described with reference to FIG. 4. In addition, operations performed by the server S20 among the operations of the method for de-duplicating an encrypted file described above will be described with reference to FIG. 5. That is, a method for storing the encrypted file C by the server S20 will be described.

FIG. 4 is a flowchart showing a process of de-duplicating an encrypted file by a client according to an exemplary embodiment of the present invention.

The client U10 hashes a plane text file M to generate a file encryption key K (ST300).

The client U10 hashes the file encryption key K to generate an encrypted file identifier Idx (ST301).

The client U10 encrypts the plane text file M using the file encryption key K to generate an encrypted file C (ST302).

The client U10 encrypts the file encryption key K using a private secret key sk to generate an encrypted file encryption key Kc (ST303).

The client U10 transmits his/her client identifier ID and the encrypted file identifier Idx to the server S20 (ST304).

In the case in which the client U10 receives a random number r from the server S20, the client U10 hashes the random number r and the encrypted file C to generate a first verification value v1 (ST305 and ST306).

The client U10 transmits the first verification value v1 to the server S20 (ST307).

In the case in which the client U10 receives a request for the encrypted file encryption key Kc from the server S20, the client U10 transmits the encrypted file encryption key Kc to the server S20 (ST308 and ST309). For example, in the case in which the first verification value v1 and a second verification value v2 coincide with each other, the client U10 may receive the request for the encrypted file encryption key Kc from the server S20.

In the case in which the client U10 does not receive the request for the encrypted file encryption key Kc from the server S20 (ST308), the client U10 ends an operation. For example, in the case in which the first verification value v1 and the second verification value v2 do not coincide with each other, the client U10 may not receive the request for the encrypted file encryption key Kc from the server S20.

Meanwhile, in the case in which the client U10 does not receive the random number r from the server S20, the client U10 transmits the encrypted file C and the encrypted file encryption key KC to the server S20 (ST305 and ST310).

The client U10 stores the encrypted file identifier Idx corresponding to the encrypted file C (ST311) in order to download the encrypted file C from the server S20 later.

FIG. 5 is a flowchart showing a process of de-duplicating an encrypted file by a server according to an exemplary embodiment of the present invention.

The server S20 receives the client identifier ID and the encrypted file identifier Idx from the client U10 (ST400).

In the case in which the same identifier as the received encrypted file identifier Idx is present in the database DB10, the server S20 generates the random number r (ST401 and ST410).

The server S20 transmits the random number r to the client U10 (ST411).

The server S20 receives the first verification value v1 from the client U10 (ST412). In the case in which the server S20 does not receive the first verification value v1 from the client U10, the server S20 may decide that the client U10 does not possess the encrypted file C.

The server S20 hashes the random number r and the encrypted file C (corresponding to the received encrypted file identifier Idx) stored in the database DB20 to generate the second verification value v2 (ST413).

In the case in which the first verification value v1 and the second verification value v2 coincide with each other, the server S20 requests the client U10 to transmit the encrypted file encryption key Kc (ST414 and ST430). In the case in which the first verification value v1 and the second verification value v2 do not coincide with each other, the server S20 informs the client U10 of fail of de-duplication and ends an operation.

The server S20 receives the encrypted file encryption key Kc from the client U10 (ST431-1).

The server S20 adds the client identifier ID received in ST400 to a field associated with the encrypted file identifier Idx received in ST400 among fields of the ID column CL1b of the database DB10 (ST432). In addition, the server S20 stores the client identifier ID and the encrypted file identifier Idx received in ST400 and the encrypted file encryption key Kc received in ST431 in the database DB30 (ST432).

Meanwhile, in the case in which the same identifier as the encrypted file identifier Idx received in ST400 is not present in the database DB10 (ST401), the server S20 requests the client U10 to transmit the encrypted file C and the encrypted file encryption key Kc for the encrypted file C (ST420).

The server S20 receives the encrypted file C possessed by the client U10 and the encrypted file encryption key Kc for the encrypted file C from the client U10 (ST421).

The server S20 stores the encrypted file identifier Idx and the client identifier ID received in ST400 in the database DB10 (ST422). In addition, the server S20 stores the encrypted file identifier Idx received in ST400 and the encrypted file C received in ST421 in the database DB20 (ST422). In addition, the server S20 stores the client identifier ID and the encrypted file identifier Idx received in ST400 and the encrypted file encryption key Kc received in ST421 in the database DB30 (ST422).

Meanwhile, a case in which the method for de-duplicating an encrypted file according to an exemplary embodiment of the present invention is applied to the encrypted file C has been hereinabove described as an example, but this is only an example. For example, in the case in which a file is divided into a plurality of blocks, the method for de-duplicating an encrypted file described above may be similarly applied to each block of the file.

The method for de-duplicating an encrypted file stated in the present specification is as follows.

The client and the server confirm whether or not the encrypted file is duplicated using the encrypted file identifier.

When the duplicated encrypted file is present in the server, the server generates the random number in order to confirm whether or not the client actually possesses the encrypted file.

The client and the server calculate (generate) verification values using the corresponding random number, respectively.

The server compares the verification value calculated by the server and the verification value calculated by the client with each other.

When the two verification values are the same as each other, the server confirms that the client possesses an actual file (or an actual encrypted file) and finally decides that the encrypted file is duplicated. In detail, in the case in which the two verification values are the same as each other, the client does not transmit the corresponding encrypted file to the server, but transmits only the encrypted file encryption key to the server, and the server stores the metadata related to the encrypted file in the databases DB10 and DB30.

In the case in which the two verification values are not the same as each other, the server informs the client of the fail of the de-duplication and ends an operation.

Meanwhile, in the case in which the duplicated encrypted file is not present in the server, the client transmits the encrypted file and the encrypted file encryption key to the server, and the server stores the encrypted file and the metadata related to the encrypted file in the databases DB10, DB20, and DB30.

Meanwhile, the databases DB10, DB20, and DB30 of the server may have the structures of the databases shown in FIG. 2 in order to store the encrypted file and the metadata related to the encrypted file.

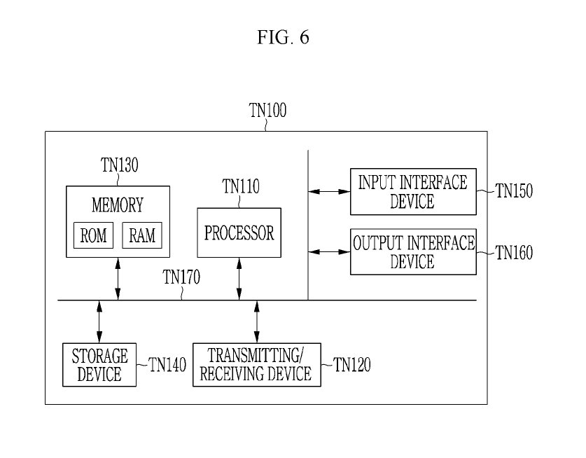

FIG. 6 is a view showing a computer apparatus according to an exemplary embodiment of the present invention.

A computer apparatus TN100 of FIG. 6 may be the client, the server, or the like, stated in the present specification.

In an exemplary embodiment of FIG. 6, the computer apparatus TN100 may include at least one processor TN110, a transmitting/receiving device TN120 connected to a network and performing communication, and a memory TN130. In addition, the computer apparatus TN100 may further include a storage device TN140, an input interface device TN150, an output interface device TN160, and the like. The components included in the computer apparatus TN100 may be connected to each other by a bus TN170 to perform communication with each other.

The processor TN110 may execute a program command stored in at least one of the memory TN130 and the storage device TN140. The processor TN110 may be a central processing unit (CPU), a graphics processing unit (GPU), or a dedicated processor in which the methods according to an exemplary embodiment of the present invention are performed. The processor TN110 may be configured to implement processes, operations, functions, and methods stated in an exemplary embodiment of the present invention. The processor TN110 may control the respective components of the computer apparatus TN100.

Each of the memory TN130 and the storage device TN140 may store various kinds of information related to the operations of the processor TN110. Each of the memory TN130 and the storage device TN140 may be formed of at least one of a volatile storage medium and a non-volatile storage medium. For example, the memory TN130 may be formed of at least one a read only memory (ROM) and a random access memory (RAM).

The transmitting/receiving device TN120 may transmit or receive wired signals or wireless signals.

According to an exemplary embodiment of the present invention, a method and an apparatus for de-duplicating an encrypted file through comparison between verification values for verifying whether or not a client possesses a file may be provided.

In addition, according to an exemplary embodiment of the present invention, it is possible to prevent a user (or a client) that does not possess an actual file from downloading a file through a de-duplicating process using an encrypted file identifier.

Further, according to an exemplary embodiment of the present invention, a method and an apparatus for de-duplicating an encrypted file that is safe against a duplicated impersonation attack may be provided.

Further, according to an exemplary embodiment of the present invention, structures of databases of a server for storing an encrypted file or metadata transmitted from a client may be provided.

Meanwhile, an exemplary embodiment of the present invention described above is not implemented through only the apparatus and/or the method described above, but may also be implemented through programs executing functions corresponding to configurations of an exemplary embodiment of the present invention, a recording medium in which the programs are recorded, and the like. In addition, these implementations may be easily made by those skilled in the art to which the present invention pertains from the exemplary embodiment described above.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for storing an encrypted file by a server, comprising:
receiving a first encrypted file identifier from a client;
generating a random number and transmitting the random number to the client, when the first encrypted file identifier is present in a first database;
generating a first verification value using the random number; and
confirming whether or not the client possesses a first encrypted file corresponding to the first encrypted file identifier among encrypted files stored in a second database by comparing the first verification value and a second verification value based on the random number with each other, when receiving the second verification value from the client.

2. The method of claim 1, wherein:
the generating of the first verification value
includes hashing the first encrypted file and the random number to calculate the first verification value, and
the second verification value is calculated by the client by hashing a second encrypted file possessed by the client and the random number.

3. The method of claim 1, wherein:
the confirming
includes requesting the client to transmit only a first file encryption key for the first encrypted file, of the first encrypted file and the first file encryption key and receiving the first file encryption key, when the first verification value and the second verification value coincide with each other, and
the first file encryption key is a file encryption key encrypted through a private secret key uniquely allocated to the client.

4. The method of claim 1, wherein:
the first database stores the first encrypted file identifier and a first client identifier list associated with the first encrypted file identifier, and
the confirming
includes adding a first client identifier of the client to the first client identifier list when the first verification value and the second verification value coincide with each other.

5. The method of claim 3, wherein:
the confirming
further includes storing a first client identifier of the client, the first encrypted file identifier, and the first file encryption key in a third database.

6. The method of claim 1, wherein:
the confirming
includes deciding that the client does not possess the first encrypted file and informing the client of fail, when the first verification value and the second verification value are different from each other.

7. The method of claim 3, wherein:
a second file encryption key is generated by hashing for a first plane text file,
the first encrypted file identifier is generated by hashing for the second file encryption key,
the first encrypted file is generated by applying encryption based on the second file encryption key to the first plane text file, and
the first file encryption key is generated by applying encryption based on the private secret key to the second file encryption key.

8. The method of claim 1, further comprising:
requesting the client to transmit a second encrypted file possessed by the client and a first file encryption key for the second encrypted file and receiving the second encrypted file and the first file encryption key, when the first encrypted file identifier is not present in the first database,
wherein the first file encryption key is a file encryption key encrypted through a private secret key uniquely allocated to the client.

9. The method of claim 8, wherein:
the receiving of the second encrypted file and the first file encryption key includes:
storing the first encrypted file identifier and a first client identifier of the client in the first database;
storing the first encrypted file identifier and the second encrypted file in the second database; and
storing the first client identifier, the first encrypted file identifier, and the first file encryption key in a third database.

10. The method of claim 1, wherein:
the first database and the second database are physically separated from each other.

11. A method for storing an encrypted file in a server by a client, comprising:
transmitting a first client identifier of the client and a first encrypted file identifier for a first encrypted file to the server;
receiving a random number from the server, when the first encrypted file identifier is present in the server;
hashing the random number and the first encrypted file to generate a first verification value; and
transmitting the first verification value to the server.

12. The method of claim 11, further comprising:
before the transmitting of the first client identifier and the first encrypted file identifier, encrypting a first file encryption key for the first encrypted file using a private secret key allocated to the client to generate a second file encryption key; and
transmitting only the second file encryption key of the first encrypted file and the second file encryption key to the server, when the first verification value and a second verification value generated by the server coincide with each other.

13. The method of claim 11, further comprising:
before the transmitting of the first client identifier and the first encrypted file identifier, encrypting a first file encryption key for the first encrypted file using a private secret key allocated to the client to generate a second file encryption key; and
receiving a fail message from the server, when the first verification value and a second verification value generated by the server are different from each other.

14. The method of claim 11, further comprising:
before the transmitting of the first client identifier and the first encrypted file identifier, encrypting a first file encryption key for the first encrypted file using a private secret key allocated to the client to generate a second file encryption key; and
transmitting the first encrypted file and the second file encryption key to the server, when the first encrypted file identifier is not present in the server.

15. The method of claim 11, further comprising:
hashing a first plane text file to generate a first file encryption key;
hashing the first file encryption key to generate the first encrypted file identifier;
encrypting the first plane text file using the first file encryption key to generate the first encrypted file; and
encrypting the first file encryption key using a private secret key allocated to the client to generate a second file encryption key.

16. A server comprising:
a first database; and
a processor searching a first encrypted file identifier in the first database when the first encrypted file identifier is received from a client,
wherein the processor transmits a random number to the client and hashes a first encrypted file corresponding to the first encrypted file identifier among encrypted files stored in a second database and the random number to generate a first verification value, when the first encrypted file identifier is searched, and
the processor compares the first verification value and a second verification value based on the random number with each other to confirm whether or not the client possesses the first encrypted file, when the second verification value is received from the client.

17. The server of claim 16, wherein:
the processor requests the client to transmit only a first file encryption key for the first encrypted file, of the first encrypted file and the first file encryption key and receives the first file encryption key, when the first verification value and the second verification value coincide with each other, and
the first file encryption key is a file encryption key encrypted through a private secret key allocated to the client.

18. The server of claim 16, wherein:
the processor adds a first client identifier of the client to a first client identifier list corresponding to the first encrypted file identifier among client identifier lists stored in the first database, when the first verification value and the second verification value coincide with each other.

19. The server of claim 17, wherein:
the processor stores a first client identifier of the client, the first encrypted file identifier, and the first file encryption key in a third database.

20. The server of claim 16, wherein:
the processor decides that the client does not possess the first encrypted file and informs the client of fail, when the first verification value and the second verification value are different from each other.
